(19) United States
(12) Patent Application Publication
(10) Pub. No.: US 2013/0190061 A1
(43) Pub. Date: Jul. 25, 2013

(54) METHOD FOR THE PREPARATION OF AGRICULTURAL CROP AND AGRICULTURAL HARVESTING MACHINE

(71) Applicant: CLAAS Selbstfahrende Erntemaschinen GmbH, Harsewinkel (DE)

(72) Inventors: Alexander Kirchbeck, Muenster (DE); Dominik Grothe, Hoexter (DE)

(73) Assignee: CLAAS Selbstfahrende Erntemaschinen GmbH, Harsewinkel (DE)

(21) Appl. No.: 13/746,726

(22) Filed: Jan. 22, 2013

(30) Foreign Application Priority Data
Jan. 25, 2012 (DE) 10 2012 100 605.9

(51) Int. Cl. A01F 12/58

(52) U.S. Cl. CPC A01F 12/58
USPC 460/1

(57) ABSTRACT

A method for preparing agricultural crop enhanced with at least one auxiliary agent and conveyed in the form of a crop flow through at least one working assembly of an agricultural harvesting machine includes detecting one or more properties of the crop via sensors and adding a quantity of the at least one auxiliary agent to the crop flow, depending on the one or more detected crop properties thereby enhancing the quality of the crop flow.

### CROSS-REFERENCE TO RELATED APPLICATION

The invention described and claimed hereinbelow is also described in German Patent Application DE 10 2012 100605.9, filed on Jan. 26, 2012. This German Patent Application, subject matter of which is incorporated herein by reference, provides the basis for a claim of priority of invention under 35 U.S.C. 119(a)-(d).

### BACKGROUND OF THE INVENTION

The invention relates to a method for the preparation of agricultural crop flow through at least one working assembly wherein at least one auxiliary agent that enhances the quality of the crop flow is added to the crop flow and wherein one or more properties of the crop are detected via sensors in order to dose the quantity of the at least one auxiliary agent depending on same detected crop properties.

In agricultural harvesting technology, the application of ensilage agents dissolved in water to the crop, of concentrate compositions or granulates are common procedures for the preparation or handling of crop. The prior art makes known, for example, self-loading forage wagons, balers or self-propelled forage harvesters, in which such auxiliary agents are continuously added to the crop (which is conveyed through the working assembly in the form of a crop flow), in order to generally enhance the quality of the crop including any subsequent silage process thereof.

Specifically, the objective of adding so-called ensilage agents can be to achieve various effects, as follows: improved fermentation of the crop; increased stability under the influence of air; reduction in grass-juice run-off; improvement in subsequent feeding in terms of feed uptake, digestibility, fattening and milk-production capability; prevention of clostridia; etc., without limitation. The use of different ensilage agents depending on the intended purpose is known. For example, acids (e.g. lactic acid) or sugar-containing liquids (e.g., molasses) are known ensilage agents.

In a simple case, the auxiliary agent is dosed as a function of time, i.e., a predefinable quantity is added to the crop flow per unit of time. A more economical use of the auxiliary agent is achieved in practical application by adding said auxiliary agent with consideration for the actual throughput of crop through the harvesting machine. This ensures that the auxiliary agent is not used unnecessarily, at least during interruptions in the conveyance of crop (for example, when turning at the end of the field, in gaps in the crop stand or when crop conveyance comes to a standstill).

Moreover, in order to dose the auxiliary agent correctly, the machine operator must have deep specialized knowledge regarding the character of the crop to ensure that the auxiliary agent is added in a quantity that is appropriate, i.e., that is required for the efficacy thereof, but that is not unnecessarily higher. Since the state of the plant stand to be harvested can differ greatly on a local basis in practical application (for example due to different ground conditions, different light conditions, the inclination of the ground, etc.), it is hardly possible to dose the auxiliary agent in an optimal manner. Inexperienced operators in particular are overtaxed by this task.

### SUMMARY OF THE INVENTION

The present invention overcomes the shortcomings of known arts, such as those mentioned above.

In an embodiment, the invention provides a method for the preparation of crop according to the initially described type, which makes use of auxiliary agents, in particular ensilage agents, in a manner that is more effective than known methods. The method ensures a reliably high quality of the harvested crop while utilizing resources as cost effectively as possible.

The invention also provides a harvesting machine that implements the serves the purpose of the method.

The method includes detecting one or more properties of the crop using sensors in order to dose the quantity of the at least one auxiliary agent depending on the crop properties that are detected.

According to the invention, one or more properties of the crop are taken into consideration in the dosing of the at least one auxiliary agent. To this end, properties of the crop conveyed through the harvesting machine are advantageously monitored continuously using sensors, thereby ensuring that the quantity to add is adjusted immediately and, in particular, according to need. Advantageously, auxiliary agent is therefore added in an automatically controlled manner, thereby sparing the operator of the harvesting machine the need to perform further monitoring. The use of auxiliary agent or agents is particularly effective and, therefore, cost effective due to the dosing thereof according to need.

The sensor-based detection of one or more properties of the crop can take place in technically different manners. Advantageously, it is possible to detect properties such as crop type, moisture, dry mass, temperature, structure, length of cut, material composition (components or substances in the contents) or other features of the crop that can be significant for the dosing of all types of auxiliary agents. Since the material composition of the crop typically plays an important role in the dosing, individual components and/or substances contained in the crop are determined on the basis of an optical, preferably a near-infrared, spectroscopic analysis.

An optical analysis according to the invention may be implemented using suitable camera technology by optically monitoring the crop flow and subsequently electronically evaluating images that are captured. Preferably, the contents are determined on the basis of a near-infrared spectroscopic analysis (NIR technology) since this makes it possible to rapidly and reliably determine a high number of content components of the crop that are relevant to the addition of an ensilage agent,. This content can include inter alia, sugar content, protein content, raw ash portion, crude fiber portion.

It is feasible to combine different measurement procedures with one another, e.g., to detect various properties of the crop in different sensor-based ways. Separate measuring methods may be used for determining the moisture and/or the temperature of the crop, for example, in addition to an optical measuring method for detecting constituents of the crop.

To ensure cost-effective use of the at least one auxiliary agent, the dosing thereof is carried out not only with consideration for properties of the crop but also, advantageously, as a function of time and/or the throughput of the crop through the harvesting machine. By considering the throughput it is possible to quickly react to fluctuations in the crop quantity, and the addition of the at least one auxiliary agent can be interrupted completely if conveyance has stopped. The crop throughput can be determined using sensors present in the machine or using a separate throughput sensor.

The method according to the invention achieves advantageous effects even when only one auxiliary agent is dosed. A plurality of auxiliary agents may be added to the crop, wherein the quantity of each of the auxiliary agents to add is dosed individually depending on the crop properties that are detected. The plurality of auxiliary agents can be ensilage agents having different effects, for example, wherein the individual dosing of each one of the auxiliary agents results in preparation matched particularly well to the crop properties. Accordingly, the invention provides for simultaneously adding a plurality of auxiliary agents in a dosable quantity, for adding only one auxiliary agent or even for adding no auxiliary agent at all (if none is required, according to the conditions).

A combined application can take place in a manner such that the plurality of auxiliary agents is intermixed before addition thereto to the crop. The intermixed auxiliary agents then form a type of “additive cocktail”, which can be matched in a highly effective manner to the state of the crop currently being harvested by way of a composition (“mixture”) that can be continuously changed during the harvesting operation.

Alternatively, or in addition thereto, auxiliary agents in different forms can be added to the crop. The particular quantity of auxiliary agent to add is dosed in a certain form depending on the crop properties that are detected. Under certain harvesting conditions (high moisture), it can be sufficient, for example, to add ensilage agent to the crop in (solid) granulate form. Since the granulate would not dissolve in the crop under relatively dry harvesting conditions, it is advantageous in this case to add the same ensilage agent to the crop, or at least an ensilage agent having the same effect as the granulate, in the liquid state (e.g. dissolved in water), and to halt the addition of the granulate. Addition can take place in any possible form (solid, liquid, gas, as an aerosol). It can be advantageous or even necessary to add auxiliary agents having a different effect in different forms.

The at least one auxiliary agent is advantageously dosed on the basis of empirically determined values (presented as a “characteristic curve” for example), which specify a suitable dose of the auxiliary agent (or agents) for certain crop properties. Since such values form a different characteristic curve for every crop type, the at least one auxiliary agent should advantageously be dosed on the basis of a crop-type specific characteristic curve. In order to select the characteristic curve, the crop type is either detected using sensors or is specified by the operator of the harvesting machine. It is also possible, as an option, to use optical (in particular near-infrared spectroscopic) measuring methods for sensor-based detection and subsequent detection of the crop type. The operator makes a specification by manually selecting the crop type in a selection menu of a control unit.

The initially stated problem is further solved by a harvesting machine configured for carrying out the above-described method. This can be an agricultural harvesting machine, such as a self-loading foraging wagon, a baler or a self-propelled forage harvester, which conveys the crop in the form of a crop flow using at least one working assembly, and which is equipped with a device for adding at least one auxiliary agent to the crop flow.

According to the invention, the harvesting machine is characterized by a sensor system assigned to the crop flow for detecting properties of the crop, means for influencing the quantity of the at least one auxiliary agent to add and a control unit that adjusts the quantity of the at least one auxiliary agent to add on the basis of information received from the sensor system.

The sensor system can be operated in parallel with different measuring methods, in order to detect different properties of the crop. In an embodiment, the sensor system comprises at least one optical measuring device, which operates on the basis of near infrared spectroscopy. In this case, at least the optical detection unit thereof is advantageously disposed in the vicinity of the crop flow. In a forage harvester, optical detection of the crop could preferably take place in the region of the upper discharge chute.

The device for adding the at least one auxiliary agent comprises at least one container for storing a substance and at least one delivery unit connected to the container. The delivery unit delivers the substance located in the at least one container to the crop flow by way of a feed. The delivery unit includes a pump designed as a variable-displacement pump or which interacts with a proportional flow control valve or the like in order to add a changeable quantity of the at least one auxiliary agent to the crop. Different designs of such a delivery unit are feasible.

In an embodiment, a plurality of containers for storing substances to be applied is provided on the harvesting machine. For example, the containers can be connected to a common mixing unit, which can be operated to mix the substances in a ratio specified by the control unit. It is therefore possible to add mixed substances, wherein the mixing unit makes it possible to adjust the quantity of individual substances in a flexible, immediate manner. To this end, the mixing unit is preferably designed in the sense of a mixing faucet, which can be used to steplessly adjust the inflow quantity of individual substances.

Alternatively, the device for applying the at least one auxiliary agent comprises a plurality of containers for storing one substance each, to each of which a separate delivery unit is connected and assigned. Each of the delivery units assigned to a container delivers the substance located in the container to the crop flow by way of a feed. The feed takes place in a structurally separated manner, for example, in order to be able to apply substances at different points of the crop flow.

Alternatively, the substances conveyed by separate delivery units are intermixed before application to the crop flow by adding the substances to the crop flow by way of a common feed. Such a design has the advantage over a mixing unit (mixing faucet) to be controlled that the quantity of the particular substance to add can be influenced directly via control of the particular delivery units. A mixing unit that has a complex design and complex controls is therefore omitted.

The auxiliary agent can be, very generally, an ensilage agent in pure form (solid, liquid, gas) or in dissolved form, or can be pure water. Water stored in the container is used to dissolve and dose active agent, after having been mixed in a dosed manner with an ensilage agent stored in a further container. In this case, the water is used as a carrier agent and makes it possible to dose the active agent to add, since the water can be added in a flexible manner.

Alternatively, or in addition thereto, water is added to the crop without addition of further substances in order to help improve the crop flow. This is significant in the harvest of sugar-containing grass, where the conveyance properties of the crop are improved by adding water in a targeted manner. In the case of forage harvesters, adding pure water relates to the on-board sharpening system, which is designed to be cooled by the water carried on-board in order to reduce the risk of fire or to cool the knives during sharpening.

The device for adding an auxiliary agent also operates to feed an auxiliary agent to a working and/or conveyance assembly of the harvesting machine. A suitable feed for the auxiliary agent to the working and/or conveyance assembly is provided for this purpose. For example, water is supplied as needed to the chopping assembly and/or to the intake assembly by way of a water line. A water feed directed to the sharpening device of the chopping assembly in a very location-specific manner is used for cooling during the sharpening procedure.

Other applications also are feasible, such as the aforementioned wetting of working and/or conveyance assemblies for the purpose of improving conveyability. The advantage of these applications is, inter alia, that storing auxiliary agents, which are intended primarily to be added to the crop, serves an additional purpose and therefore only slightly increases the complexity.

The feed of the auxiliary agent to the working and/or conveying assembly can be actuated manually by the machine operator, triggered, for example, by the opening of a valve or by switching on an electric delivery pump for the auxiliary agent. The feed of the auxiliary agent to the working assembly takes place in an event-specific manner. Hence, the above-described cooling of the sharpening device could be coupled to the event “carry out the sharpening procedure” and be triggered automatically by the sharpening procedure. The machine operator is thereby relieved and risks of fire would always be minimized.

### BRIEF DESCRIPTION OF THE DRAWINGS

Further features and advantages of the invention will become apparent from the description of embodiments that follows, with reference to the attached figures, wherein:

FIG. 1 depicts an agricultural harvesting machine in the form of a self-propelled forage harvester in a schematic side view.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

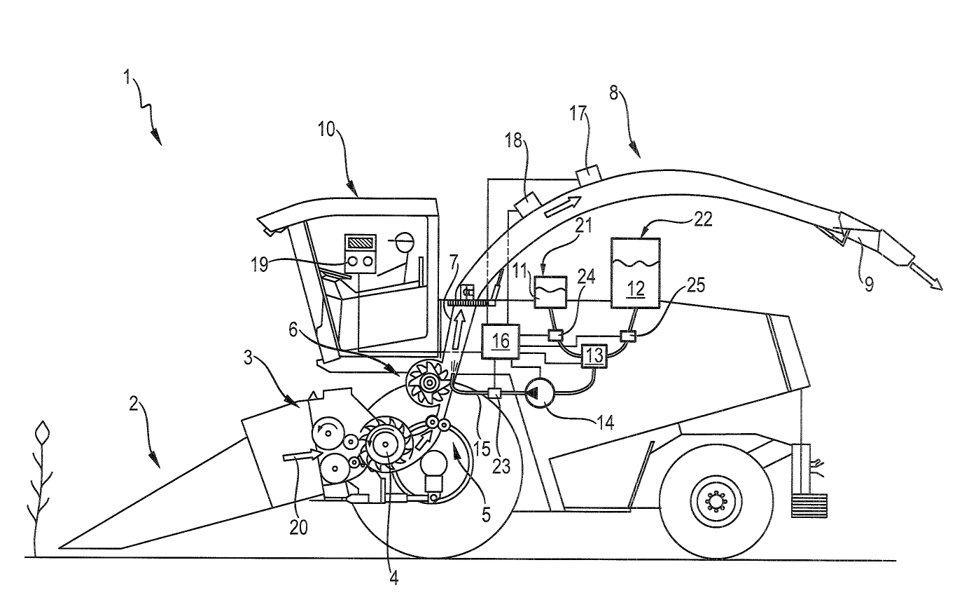

FIG. 1 depicts an agricultural harvesting machine according to the invention in the form of a self-propelled forage harvester 1. The forage harvester 1 is configured for carrying out the method. For that matter, the invention can be implemented on other harvesting machines that process a crop flow, for example self-loading forage wagons or balers, and results in comparable effects and advantages.

Forage harvester 1 is equipped with front and rear wheels for travel over a field having a plant stand (indicated by way of a plant, which is not described in further detail), and is driven via an engine. In a manner known per se, in the harvesting operation, the forage harvester 1 cuts plant material from the field using a front harvesting attachment 2 mounted on the front side of the machine frame and feeds the crop 20 obtained in this manner to an intake assembly 3 equipped with a plurality of compression rollers (the conveyance path through the machine is indicated by arrows).

After precompression there, the crop 20 reaches the chopper drum 4, which fragmentizes the crop 20 via interaction with a stationary shear bar (not shown). By way of a conveyor chute 7, which rises downstream of the chopper drum 4, the chopped crop 20 is processed by a conditioning device 5 (optional) and is additionally accelerated by a post-accelerator 6. The accelerated crop 20 then enters an arcuate transfer device 9, in order to be ejected from the forage harvester 1 via the discharge flap 9 thereof. The discharge flap 9 faces away from the machine, for loading a (not-shown) collecting container.

In practical application, the ejected crop is often subjected to an ensilage process for preservation and/or general refinement in order to be subsequently fed to livestock. Certain properties of the crop that promote desired biological and chemical processes in the crop are required in order to trigger or effectively maintain the ensilage process and, therefore, to achieve a good ensilage result. Since these properties are not always naturally present, the forage harvester 1 comprises a system for adding at least one auxiliary agent that promotes the ensilage process and, therefore, the quality of the crop 20.

To this end, two containers are stored on-board the forage harvester 1, namely a first storage container 21 and a second storage container 22. The first storage container 21 is filled with a liquid ensilage agent 11, which contains lactic acid bacteria, for example. The first storage container is advantageously thermally insulated in order to prevent the temperature of the ensilage agent 11 from rising and, therefore, to prevent the lactic acid bacteria from dying. The second storage container 22 is filled with water 12.

Two outlet openings are provided on the underside of the containers, in order to connect each of the storage containers 21, 22 to a common mixing unit 13 by way of a line. A flow meter 24 and 25 is provided at each of the lines between a first storage container 21 and a mixing unit 13, and between a second storage container 22 and a mixing unit 13, respectively. The flow meter detects the particular flow through the line and, therefore, the outflow from the first storage container 21 and the second storage container 22, respectively. The flow meters 24, 25 transmit relevant flow-rate signals to a central control unit 16.

The mixing unit 13 has a signal-based connection to the central control unit 16, in order to be actuated by the control unit 16. On the basis of control signals that are received, the mixing unit 13 is capable of throttling the outflow quantities (=flow rates) of the ensilage agent 11 and the water 12 through the particular lines to the mixing unit 13 by any extent within a range of 0% to 100% in the sense of a mixing faucet. In this manner, the mixing faucet 13 mixes the two liquids 11, 12 in any settable ratio. In one extreme case, pure ensilage agent 11 emerges from an output-side outlet of the mixing unit 13 and in the other extreme case pure water 12 emerges from an output-side outlet of the mixing unit 13. Any mixing ratios therebetween can be set. Complete blockage of the mixing unit 13 is also possible if none of the auxiliary agents are required, due to the harvesting conditions.

A delivery pump 14 having a variable capacity is connected via a line to the output-side outlet of the mixing unit 13 in order to pump the liquid mixture, in the arrow direction shown at the pump 14, first through a further flow meter 23 (for the total quantity to add) and finally through an injector 15. The injector terminates in the conveyor chute 7 and opens in the direction of flow of the crop 20, thereby applying the mixture in a finely sprayed form onto the crop 20 flowing past.

The delivery pump 14 is activated via the control unit 16, thereby permitting the total quantity of the liquid mixture to add (which is fed to the crop 20 via the injector 15) to be controlled by changing the pump output. The flow meter 23, the flow signal of which is transmitted to the control unit 16, is used as feedback to regulate the total quantity.

The forage harvester 1 comprises a sensor system for detecting properties of the crop 20 for the purpose of automatically setting an effective dose of auxiliary agents that are added. In the example shown, the sensor system comprises two sensors 17, 18 which are disposed on the back wall of the transfer device 8.

The sensor 17 is an optical sensor, which is suitable for optically detecting crop 20 that is flowing past in such a way that properties of the crop 20 can be determined on the basis of an analysis of the optical signals that are produced. Very generally, the properties can be, for example, moisture or dry mass, the physical state (inter alia, length of cut, structure), the composition of the contents, etc. An optical sensor that functions on the basis of near infrared spectroscopy makes it possible, in a technically suitable manner, to reliably determine ingredients or moisture of the crop 20. Such determination is advantageous for dosing auxiliary agents in a particularly differentiated manner. To this end, the sensor 17 has a signal-based connection to the control unit 16, thereby enabling the control unit 16 to react as quickly as possible to properties of the crop 20 that are actually present by dosing the auxiliary agent(s) 11, 12 accordingly.

The sensor 18 (optional) is an additional measuring device in the form of a moisture sensor. This sensor can operate, for example, according to the principle of an electric conductance sensor. A temperature sensor also can be integrated therein, in order to increase the accuracy of the moisture measurement by way of a combined measured-value analysis (conductance and temperature of the crop). The sensor 18 also has a signal-based connection to the control unit 16, thereby enabling the control unit 16 to react to moisture values of the crop 20 that are determined.

The forage harvester 1 further comprises a driver's cab 10, in which a control terminal 19 is disposed in a manner accessible by a machine operator. The control terminal has a communication link to the control unit 16. All the settings for adding ensilage agent are carried out via the control terminal 19. In particular, desired quantities to be applied are set manually and/or control limits for automatic dosing can be set.

Advantageously, the operator selects between different crop types, wherein, when a crop type is selected, the auxiliary agent is dosed on the basis of a characteristic curve specific for the crop type, which is stored in a data base. Alternatively, in a fully automated mode, the crop type is detected automatically, for example, by way of the optical sensor 17, thereby eliminating a need for manual selection.

The control terminal 19 further comprises a display for all the information associated with the addition of auxiliary agent. Within the scope of order management performed by the forage harvester 11, it is possible to document relevant data such as the quantities of auxiliary agents to add. Also, documentation can be carried out in a location-specific manner, for the purpose of which localization could be carried out using a suitable position-finding system of the forage harvester (GPS, wireless communication, etc.). Conversely, in addition to the crop properties detected using sensors, position information also can be used for dosing the auxiliary agent in order to add the auxiliary agent in a geo-referenced manner. Hence, it is possible to add auxiliary agent very specifically only to subregions of a field.

Auxiliary agent(s) also can be added in a manner other than that described using the forage harvester 1. In particular, numerous deviating arrangements and designs of the storage containers and the delivery and dosing elements are possible. For example, instead of two storage containers, any number of storage containers may be used to simultaneously or selectively use a large bandwidth of useful auxiliary agents. For example, instead of (or in addition to) water, different acids and/or sugar-containing liquids (e.g. molasses) can be kept on hand as auxiliary additives. The storage containers also are suitable as auxiliary agents in a form other than liquid, e.g., in a solid (granulate) or gaseous state. A feed, delivery and dosing technique adapted to the auxiliary agent is then required.

Storing different auxiliary agents separately has the advantage that the quantity thereof to add relative to the other auxiliary agent(s) is not established until directly before application thereof to the crop. The result is high flexibility during the harvesting operation, thereby making it possible to react to changed crop conditions on short notice. Furthermore, agents that have been used up can be refilled separately without restriction.

The following dosing measures, for example, can be advantageous for harvesting grass:

decreasing sugar content: increase the addition of molasses,

protein content rises above the limit value: start adding molasses,

raw ash portion rises above the limit value: start adding an agent to prevent feed contamination,

sugar content is very low: add acids.

The following dosing measures, for example, can be advantageous for harvesting corn:

increase in crude fiber content: use enzymatic ensilage agent,

raw ash portion rises above the limit value: start adding an agent to prevent feed contamination.

Very generally, the particular auxiliary agent is applied in different manners, for example, at a different point in the harvesting machine or in a different form (solid, liquid, gas). While water and an ensilage agent are applied to the crop flow in a premixed state, that is, as a mixture, these also can be added via separate line paths and at different points of the crop flow.

For that matter, a plurality of application options can be provided for the auxiliary agent water, in particular, to add water (in pure form) to the crop 20 very specifically in the region of the intake assembly 3 or at the post-accelerator 5. In this manner, the crop flow is improved when grass having very high sugar content is harvested.

In addition, the water contained in one of the storage containers can be used via spraying to cool a sharpening system provided for the knives of the chopper drum, in order to reduce the risk of fire and/or to prevent the knives from burning out. In this case, an additional feed for the water (not shown in the figure) is required.

The following list of reference signs of various elements mentioned above is included (as follows), for ease of explanation:

### LIST OF REFERENCE CHARACTERS

1 forage harvester
2 front harvesting attachment
3 intake assembly
4 chopper drum
5 conditioning device
6 post-accelerator
7 conveyor chute
8 transfer device
9 discharge flap
10 driver's cab
11 ensilage agent
12 water
13 mixing unit
14 delivery pump
15 injector
16 control unit
17 optical sensor
18 moisture sensor
19 control terminal
20 crop
21 first storage container
22 second storage container
23 flow meter
24 flow meter
25 flow meter

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for preparing an agricultural crop (20) enhanced with at least one auxiliary agent (11, 12) and conveyed in the form of a crop flow through at least one working assembly (3, 4, 5, 6) of an agricultural harvesting machine (1), comprising the steps of:
detecting one or more properties of the crop (20) via sensors; and
adding a quantity of the at least one auxiliary agent (11, 12) to the crop flow, depending on the one or more detected crop properties thereby enhancing the quality of the crop flow.

2. The method according to claim 1, wherein the step of detecting includes that individual components of the crop (20) are detected on the basis of an optical spectroscopic analysis.

3. The method according to claim 2, wherein the optical spectroscopic analysis is perform in the near-infrared range.

4. The method according to claim 1, wherein the step of detecting includes measuring the moisture and/or temperature of the crop (20).

5. The method according to claim 1, wherein the step of adding includes dosing the at least one auxiliary agent (11, 12) s a function of time or of the crop throughput through the harvesting machine (1).

6. The method according to one of the claim 1, wherein the step of adding includes that a plurality of auxiliary agents (11, 12) can be added to the crop (20) and the quantity of each of the auxiliary agents (11, 12) is dosed individually depending on the crop properties that are detected.

7. The method according to claim 6, wherein the step of adding includes that the plurality of auxiliary agents (11, 12) is intermixed before addition thereof to the crop (20).

8. The method according to claim 1, wherein the step of adding includes adding auxiliary agents (11, 12) to the crop (20) in different forms, depending on the crop properties that are detected.

9. The method according to claim 1, wherein the step of adding includes that the at least one auxiliary agent (11, 12) is dosed depending on a crop-type specific characteristic curve and wherein, in order to select the characteristic curve, the crop type is either detected by way of sensors or is specified by the operator of the harvesting machine (1).

10. An agricultural harvesting machine comprising
at least one working assembly (3, 4, 5, 6) for conveying (20) in the form of a crop flow,
a device (13, 14, 15, 21, 22) for adding at least one auxiliary agent (11, 12) to the crop flow,
a sensor system (17, 18) assigned to the crop flow, which detects properties of the crop (20), and
a control unit (16) that adjusts a quantity of the at least one auxiliary agent (11, 12) added based on information received from the sensor system (17, 18).

11. The agricultural harvesting machine (1) according to claim 10, further comprising means (13, 14) for influencing the quantity of the at least one auxiliary agent (11, 12) added.

12. The agricultural harvesting machine (1) according to claim 10, wherein the sensor system (17, 18) comprises an optical measuring device (17).

13. The agricultural harvesting machine (1) according to claim 12, wherein the optical measuring device (17) is a near infrared spectroscopy device.

14. The agricultural harvesting machine (1) according to claim 13, wherein the device (13, 14, 15, 21, 22) comprises at least one container (21, 22) for storing a substance (11, 12) and at least one delivery unit (14) connected to the container (21, 22) and wherein the at least one delivery unit delivers the substance (11, 12) located in the at least one container (21, 22) via a feed (15) to the crop flow and/or any other application point.

15. The agricultural harvesting machine (1) according to claim 14, wherein the device (13, 14, 15, 21, 22) comprises a plurality of containers (21, 22) for storing one substance (11, 12) each and wherein the containers (21, 22) are connected to a common mixing unit (13), the common mixing unit operating to mix the substances (11, 12) in a ratio specified by the control unit (16).

16. The agricultural harvesting machine according to claim 15, wherein the device (13, 14, 15, 21, 22) comprises a plurality of containers for storing one substance (11, 12) each, to each of which a separate delivery unit is connected and assigned and wherein each of the delivery units assigned to a container delivers the substance located in the container to the crop flow by way of a feed.

17. The agricultural harvesting machine according to claim 10, wherein the device (13, 14, 15, 21, 22) supplies an auxiliary agent (12) to a working and/or conveying assembly (2, 3, 4, 5, 6, 7, 8, 9) of the harvesting machine.

18. The agricultural harvesting machine according to claim 10, wherein the auxiliary agent (12) is fed to the working assembly (2, 3, 4, 5, 6, 7, 8, 9) in an event-specific manner.
